(19) United States
(12) Patent Application Publication
(10) Pub. No.: US 2012/0327349 A1
(43) Pub. Date: Dec. 27, 2012

(54) INTEGRATED PANEL OF TOUCH PANEL AND PHASE MODULATOR AND SWITCHABLE STEREOSCOPIC DISPLAY DEVICE USING THE SAME

(76) Inventors: Wen-Chun Wang, Taichung City (TW); Jyh-Yeuan Ma, Taoyuan County (TW); Chong-Yang Fang, Taichung City (TW); Chong-Wei Li, Changhua County (TW)

(21) Appl. No.: 13/303,148

(22) Filed: Nov. 23, 2011

(30) Foreign Application Priority Data
Jun. 22, 2011 (TW) 100121886

(51) Int. Cl. G02F 1/1343

(52) U.S. Cl. 349/139

(57) ABSTRACT

The present invention provides an integrated panel of a touch panel and a phase modulator including a first transparent substrate, a second transparent substrate, a liquid crystal layer, a first transparent electrode layer, a second transparent electrode layer, a third transparent substrate, and a third transparent electrode layer. The first transparent substrate, the second transparent substrate, the liquid crystal layer, the first transparent electrode layer and the second transparent electrode layer constitute the phase modulator, and the second transparent electrode layer, the second transparent substrate, the third transparent substrate and the third transparent electrode layer constitute the touch panel.

### BACKGROUND OF THE INVENTION

1. Field of the Invention

The present invention generally relates to the field of an integrated panel of a touch panel and a phase modulator, and a switchable stereoscopic display device using the same.

2. Description of the Prior Art

In the past few years, in the field of consumer electronic products, touch panels have been widely used in electronic devices, such as smart phones, GPS navigator system, personal digital assistants (PDA), laptop PCs, or even in personal computers and digital home appliances, to serve as the interface for communication between the user and the electronic device. Nowadays, stereoscopic displays are further developed to be able to show three-dimensional images. In conventional fabricating methods, in order to integrate the touch function into stereoscopic displays, a touch panel is usually directly adhered to a stereoscopic display.

Please refer to FIG. 1. FIG. 1 is a schematic, cross-sectional diagram showing a conventional stereoscopic display panel with touch function. As shown in FIG. 1, the conventional stereoscopic display 10 is fabricated by integrating a display panel 12, a phase modulator 14, and a touch panel 16 together. The phase modulator 14 is disposed above the display panel 12 and the touch panel 16 is disposed above a light-emitting face of the phase modulator 14. In general, each polarized phase of left eye images and right eye images showed by the display panel 12 may be changed via the phase modulator 14. Therefore, when accompanied with polarized glasses, the different images received respectively by the two eyes of the viewer may be integrated in the viewer's brain to generate stereoscopic display effect.

A conventional stereoscopic display with touch function fabricating method, however, requires at least six transparent substrates, which generates several drawbacks like heavier weight, higher cost, and lower transparency. In light of the above, there is still a need to reduce the weight and the cost of the stereoscopic display devices.

### SUMMARY OF THE INVENTION

One objective of the invention is to provide an integrated panel of a touch panel and a phase modulator, and a switchable stereoscopic display device using the same, which can reduce the weight and the cost of the integrated panel.

To this end, the invention provides an integrated panel of a touch panel and a phase modulator. The integrated panel includes a first transparent substrate, a second transparent substrate, a liquid crystal layer, a first transparent electrode layer, a second transparent electrode layer, a third transparent substrate, and a third transparent electrode layer. The second transparent substrate is disposed opposite to the first transparent substrate and the liquid crystal layer disposed between the first transparent substrate and the second transparent substrate. The first transparent electrode layer is disposed between the first transparent substrate and the liquid crystal layer, and the second transparent electrode layer is disposed between the second transparent substrate and the liquid crystal layer, wherein the first transparent substrate, the second transparent substrate, the liquid crystal layer, the first transparent electrode layer, and the second transparent electrode layer constitute the phase modulator. The third transparent substrate is disposed opposite to the second transparent substrate, wherein the second transparent substrate is disposed between the first transparent substrate and the third transparent substrate. The third transparent electrode layer is disposed between the second transparent substrate and the third transparent substrate, wherein the second transparent electrode layer, the second transparent substrate, the third transparent substrate, and the third transparent electrode layer constitute the touch panel.

In another aspect, the invention provides a switchable stereoscopic display device. The switchable stereoscopic display device includes a display panel and an integrated panel. The display panel includes a plurality of pixels arranged in an array and is disposed opposite to the integrated panel. The integrated panel includes a first transparent substrate, a second transparent substrate, a liquid crystal layer, a first transparent electrode layer, a second transparent electrode layer, a third transparent substrate, and a third transparent electrode layer. The second transparent substrate is disposed opposite to the first transparent substrate, and the liquid crystal layer is disposed between the first transparent substrate and the second transparent substrate. The first transparent electrode layer is disposed between the first transparent substrate and the liquid crystal layer, and the second transparent electrode layer is disposed between the second transparent substrate and the liquid crystal layer, wherein the first transparent substrate, the second transparent substrate, the liquid crystal layer, the first transparent electrode layer, and the second transparent electrode layer constitute the phase modulator. The third transparent substrate is disposed opposite to the second transparent substrate, wherein the second transparent substrate is disposed between the first transparent substrate and the third transparent substrate. The third transparent electrode layer is disposed between the second transparent substrate and the third transparent substrate, wherein the second transparent electrode layer, the second transparent substrate, the third transparent substrate, and the third transparent electrode layer constitute the touch panel.

The integrated panel which integrates a touch panel and a phase modulator into the same panel enables a switchable stereoscopic display panel to keep its touch function, even when the switchable stereoscopic display panel displays two-dimensional images. Furthermore, the switchable stereoscopic display panel may be switched to display three-dimensional (3D) images. This way, the number of transparent substrates may be reduced and steps for fabricating additional transparent electrode layer may be omitted. Therefore, the method for fabricating the integrated panel is cost-effective.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic, cross-sectional diagram showing a conventional stereoscopic display panel with a touch function.

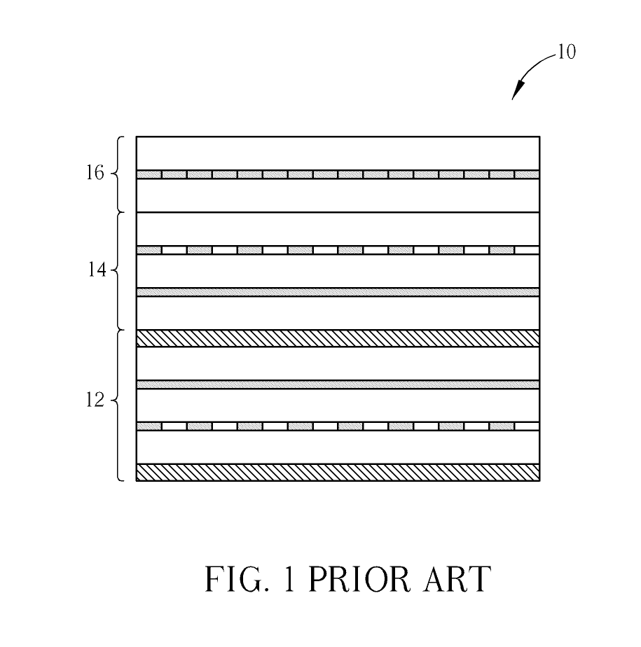

FIG. 2 is a three-dimensional schematic diagram showing a switchable stereoscopic display device according to the first embodiment of the invention.

FIG. 3 is a schematic, cross-sectional diagram taken along a line AA′ in the FIG. 2.

FIG. 4 is a schematic diagram showing a polarized light phase not changed by a phase modulator according to the first embodiment of the invention.

FIG. 5 is a schematic diagram showing a polarized light phase changed by a phase modulator according to the first embodiment of the invention.

FIG. 6 is a schematic, cross-sectional diagram showing a switchable stereoscopic display device according to the second embodiment of the invention.

FIG. 7 is a three-dimensional schematic diagram showing a switchable stereoscopic display device according to the second embodiment of the invention.

FIG. 8 is a schematic, cross-sectional diagram taken along a line BB′ in the FIG. 7.

It should be noted that all the figures are for illustration only. Relative dimensions and proportions of parts of the drawings are exaggerated or reduced in size, for the sake of clarity and convenience. The same reference numbers are generally used to refer to corresponding or similar features in modified and different embodiments.

### DETAILED DESCRIPTION

In the following description, numerous specific details are given to provide a thorough understanding of the invention. It will, however, be apparent to one skilled in the art, that the invention may be practiced without these specific details. Furthermore, some well-known system configurations and process steps are not disclosed in detail, as these should be well-known to those skilled in the art.

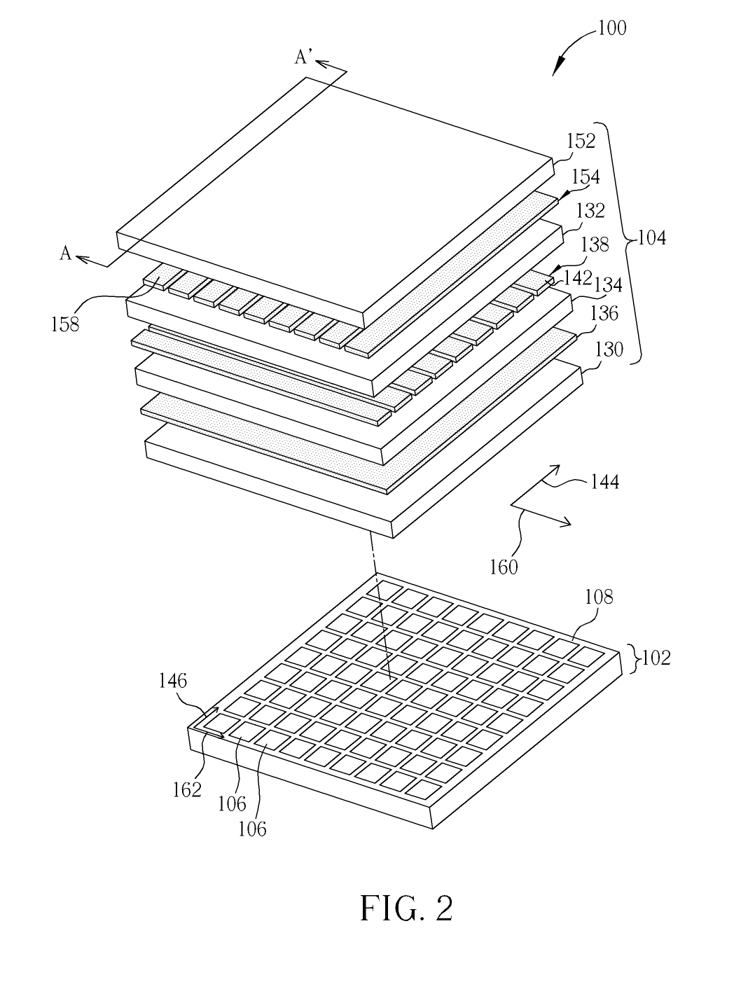

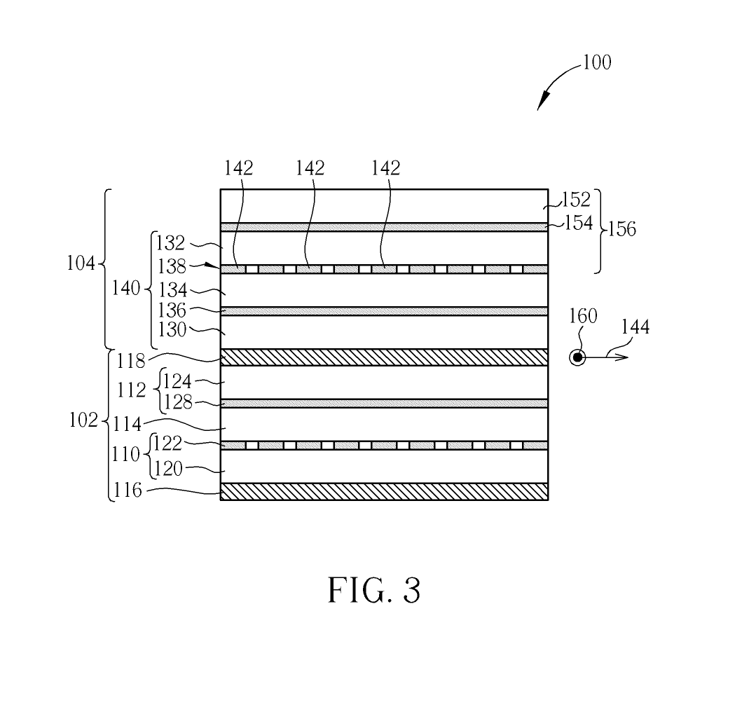

Please refer to FIG. 2 and FIG. 3. FIG. 2 is a three-dimension schematic diagram showing a switchable stereoscopic display device according to a first embodiment of the invention. FIG. 3 is a schematic, cross-sectional diagram taken along a line AA′ in the FIG. 2. As shown in FIG. 2 and FIG. 3, a switchable stereoscopic display device 100 includes a display panel 102 and an integrated panel 104 of a touch panel 156 and a phase modulator 140, wherein the display panel 102 includes a plurality of pixels 106 arranged in an array, which is used to display an image. The integrated panel 104 is disposed opposite to the display panel 102 and a display surface 108 of the display panel 102 faces the integrated panel 104. In this configuration, light rays carrying the images emitted by the display panel 102 must be transmitted through the integrated panel 104 with a phase modulator 140 before being displayed, with the integrated panel 104 being able to modify the phase polarization. The above-mentioned display panel 102 may be a liquid crystal display panel, an organic light emitting diode panel, or a plasma display panel, but is not limited thereto. In this embodiment, the display panel 102 is a liquid crystal panel which includes an array substrate 110, a color filter substrate 112, a first liquid crystal layer 114, and two polarizers 116, 118. With the polarizers 116, 118 disposed on the outside of the array substrate 110 and the outside of the color filter substrate 112 respectively, the array substrate 110, a first liquid crystal layer 114, and a color filter substrate are sandwiched between the polarizers 116, 118. The array substrate 110 includes a substrate 120 and a plurality of transparent pixel electrodes 122, wherein the transparent pixel electrodes 122 are disposed between the substrate 120 and the first liquid layer 114, and are disposed relatively to each pixel 106. The color filter substrate 112 includes a substrate 124 and a transparent common electrode 128, wherein the transparent common electrode 128 is disposed between the substrate 124 and the first liquid crystal layer 114. According to this embodiment, when no voltage is applied to the first liquid crystal layer 114, the polarized phase of the light transmitted through the first liquid crystal layer 114 is retarded by one half-wave by the first liquid crystal layer 114. When a voltage is applied to the first liquid crystal layer 114, the polarized phase of the light transmitted through the first liquid crystal layer 114 is not retarded. If the polarizing direction of the polarizers 116, 118 are perpendicular to each other, the display panel 102 is in a dark state when a voltage is applied between the transparent pixel electrodes 122 and the transparent common electrode 128. On the contrary, the display panel 102 is in a bright state when no voltage is applied between the transparent pixel electrodes 122 and the transparent common electrode 128. According to another embodiment of the invention, the polarizing direction of the polarizers 116, 118 may, however, be parallel to each other.

In addition, the integrated panel 104 includes a first transparent substrate 130, a second transparent substrate 132, a second liquid crystal layer 134, a first transparent electrode layer 136, and a second transparent electrode layer 138. The second transparent substrate 132 is disposed opposite to the first transparent substrate 130. The first transparent substrate 130 is disposed between the display panel 102 and the second transparent substrate 132. The second liquid crystal layer 134 is disposed between the first transparent substrate 130 and the second transparent substrate 132. The first transparent electrode layer 136 is disposed between the first transparent substrate 130 and the second liquid crystal layer 134 while the second transparent electrode layer 138 is disposed between the second liquid crystal layer 134 and the second transparent substrate 132, wherein the second transparent electrode layer 138 is in contact with the second transparent substrate 132. Therefore, the first transparent substrate 130, the second transparent substrate 132, the second liquid crystal layer 134, the first transparent electrode layer 136, and the second transparent electrode layer 138 constitute a phase modulator 140. According to this embodiment, the first transparent electrode layer 136 covers the display surface 108 of the display panel 102, which works as a common electrode of the phase modulator 140. The second transparent electrode layer 138 includes a plurality of first sensing electrodes 142 arranged along a first direction 144. The integrated panel 104 works as the phase modulator 140 when the switchable stereoscopic display device 100 displays 3D images. In this case, the second transparent electrode layer 138 works as a driving electrode of the phase modulator 140. The orientation of the liquid crystal molecules located in the second liquid crystal layer 134 may be modulated by applying a voltage between the first transparent electrode layer 136 and the second transparent electrode layer 138. That is, the polarized phase of the light transmitted through the second liquid crystal layer 134 can be modified. According to this embodiment, the first direction 144 is the same as that of a column direction 146 in the array, and the number of first sensing electrodes 142 is equal to that of pixels in the same column. Moreover, each of the first sensing electrodes 142 overlaps with the pixels 106 in each row. Therefore, as the pixels 106 in each row show different images by a time sequential method, each of the first sensing electrodes 142 can be operated to change the orientation of the liquid crystal molecules, with respect to the on-off states of the pixels 106 in each row.

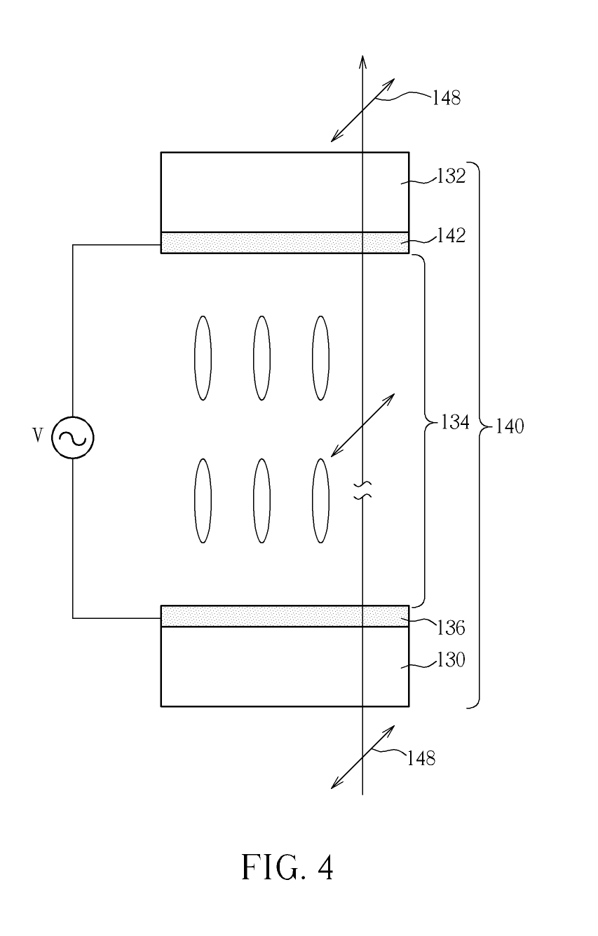

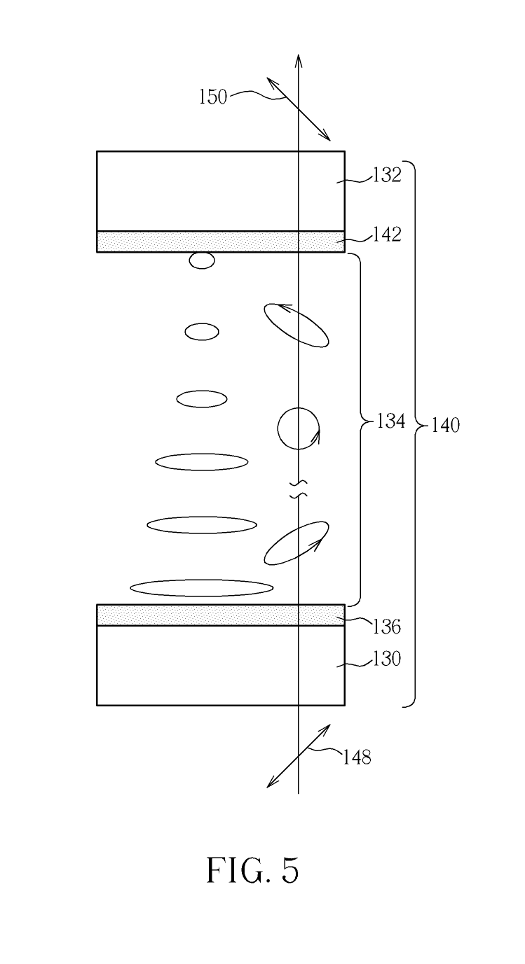

In order to clarify the operating procedure of the phase modulator as a switchable stereoscopic display device shows 3D images, the detailed elements are described as follows. Please refer to FIG. 4 and FIG. 5 and also refer to FIG. 3. FIG. 4 is a schematic diagram showing the phase modulator without changing the polarized phase of the light, according to the first embodiment of the invention. FIG. 5 is a schematic diagram showing the phase modulator changing the polarized phase of the light, according to the first embodiment of the invention. As shown in FIG. 3 and FIG. 4, when the display panel 102 shows an image, for example, a right eye image, the light rays of the right eye image emitted into the phase modulator 140 have a first polarizing direction 148. At this time, a voltage is applied between the first sensing electrodes 142 and the first transparent electrode layer 136, so that the long axis of each liquid crystal molecules in the second liquid crystal layer 134 is approximately perpendicular to the phase modulator 140. As a result, the polarized phase, i.e. the first polarizing direction 148, of the right eye image is not changed by the second liquid crystal layer 134.

Please refer to FIG. 3 and FIG. 5. When the display panel 102 shows another image, for example, a left eye image, the light rays of the left eye image emitted into the phase modulator 140 also has the first polarizing direction 148. However, contrary to the previous example, no voltage is applied between the first sensing electrodes 142 and the first transparent electrode layer 136. The polarized phase of the light of the left eye image is retarded by a half-wave once the left eye image is transmitted through the second liquid crystal layer 134. Therefore, the left eye image has a second polarizing direction, with a half-wave phase difference from the first polarizing direction. In this embodiment, the switchable stereoscopic display device 100 is accompanied with linearly polarized glasses. Each lens of the linearly polarized glasses has an absorption axis direction perpendicular to each other, so that the left eye image and the right eye image may be transmitted through each lens respectively, and further combined into a 3D image.

Please refer back to FIG. 2 and FIG. 3. The integrated panel 104 further includes a third transparent substrate 152 and a third transparent electrode layer 154. The third transparent substrate 154 is disposed opposite to the second transparent substrate 132, wherein the second transparent substrate 132 is disposed between the first transparent substrate 130 and the third transparent substrate 152. The third transparent electrode layer 154 is disposed between the second transparent substrate 132 and the third transparent substrate 152, wherein the third transparent electrode layer 154 is in contact with the second transparent substrate 132. The second transparent electrode layer 138, the second transparent substrate 132, the third transparent substrate 152, and the third transparent electrode layer 154 constitute a touch panel 156 which provides touch function as a switchable stereoscopic display device 100 shows 2D images. According to this embodiment, the third transparent electrode layer 154 includes a plurality of second sensing electrodes 158 arranged along a second direction 160. The second direction 160 is approximately perpendicular to the first direction 144 and is the same as a row direction 162 in the array. The number of the second sensing electrodes 158 is equal to the number of pixels 106 in the same row. Moreover, each of the second sensing electrodes 158 overlaps with the pixels 106 in each column. Moreover, each second sensing electrode 158 may respectively interact with each first sensing electrode 142 to produce coupling capacitance. Each first sensing electrode 142 is electrically connected to column controlling ICs, to detect changes in the capacitance induced by the first sensing electrodes 142. While each second sensing electrodes 158 is electrically connected to row controlling ICs, to detect changes in the capacitance induced by the second sensing electrodes 158. It should be noted that, according to this embodiment, only the second sensing electrodes 158 are disposed between the second transparent substrate 132 and the third transparent substrate 152, that is to say, there are no sensing electrodes perpendicular to the second sensing electrodes 158 between two adjacent second sensing electrodes 158. Therefore, steps for fabricating additional transparent electrode layer between the second transparent substrate 132 and the third transparent substrate 152 may be omitted. The method for fabricating the integrated panel 104 is therefore cost-effective.

In the switchable stereoscopic display device 100, the integrated panel 104 works as the touch panel 156 when the display panel 102 is switched to show 2D images. At this time, the first sensing electrodes 142 and the second sensing electrodes 158 are used as sensing electrodes of the touch panel 156, which can detect the change in the capacitance as a conductive object, for example, a finger, contacts the touch panel 156. In this embodiment, the touch panel 156 uses sensing functions with a mutual capacitance method. Controlling ICs may sequentially provide scanning signal to each of the first sensing electrodes 142 and detect the changes in the coupling capacitance of each second sensing electrodes 158. As a finger touches the third transparent substrate 152, the second sensing electrodes 158 and the first sensing electrodes 142, which are adjacent to the touching position, may produce a coupling capacitance with the finger. Therefore, the controlling ICs can detect the touching position, that is, adjacent to where the second sensing electrodes 158 show reduced coupling capacitance. The present invention is not limited to the mutual capacitance method; it is also suitable for detection with a self capacitance method.

The following description details other embodiments or modifications of the present invention. In order to simplify and show differences between other embodiments or modifications in the above-mentioned embodiment, the same numbers denote the same components and the same parts, and therefore are not redundantly detailed for sake of clarity and convenience.

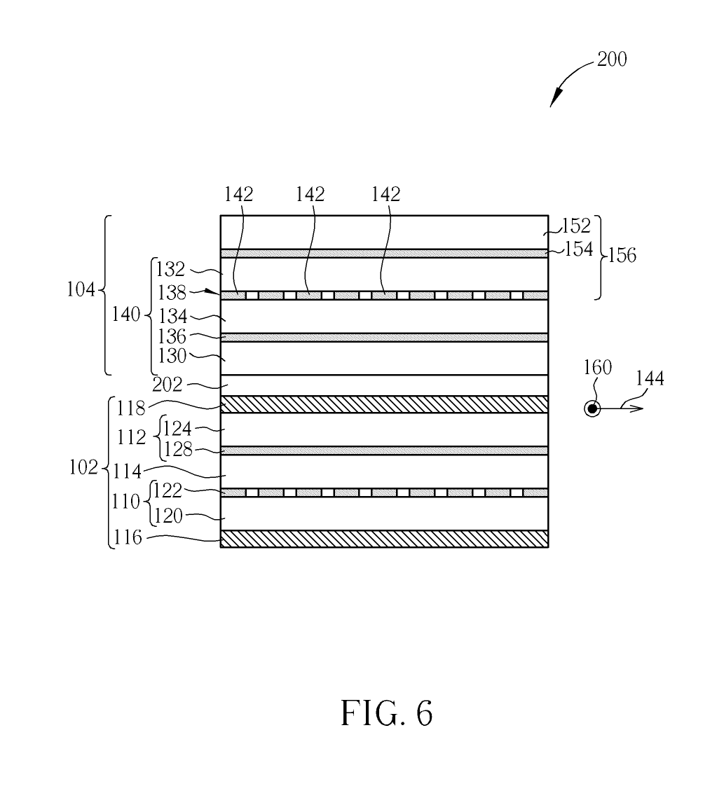

FIG. 6 is a schematic, cross-sectional diagram showing a switchable stereoscopic display device according to the second embodiment of the invention. As shown in FIG. 6, compared to the first embodiment, a switchable stereoscopic display device 200 further includes a quarter-wave retardation plate 202 disposed between a display panel 102 and an integrated panel 104. The quarter-wave phase retardation plate 202 can transfer a linearly polarized light transmitting through a polarizer 118 into a circularly polarized light. When there is no voltage applied between the first transparent electrode layer 136 and the second transparent electrode layer 138, the polarizing direction of the circularly polarized light is changed to another direction after the circularly polarized light is transmitted through a phase modulator 140, for example, changed from left-handed circularly polarized light (LHC) to right-handed circularly polarized light (RHC) and vice versa.

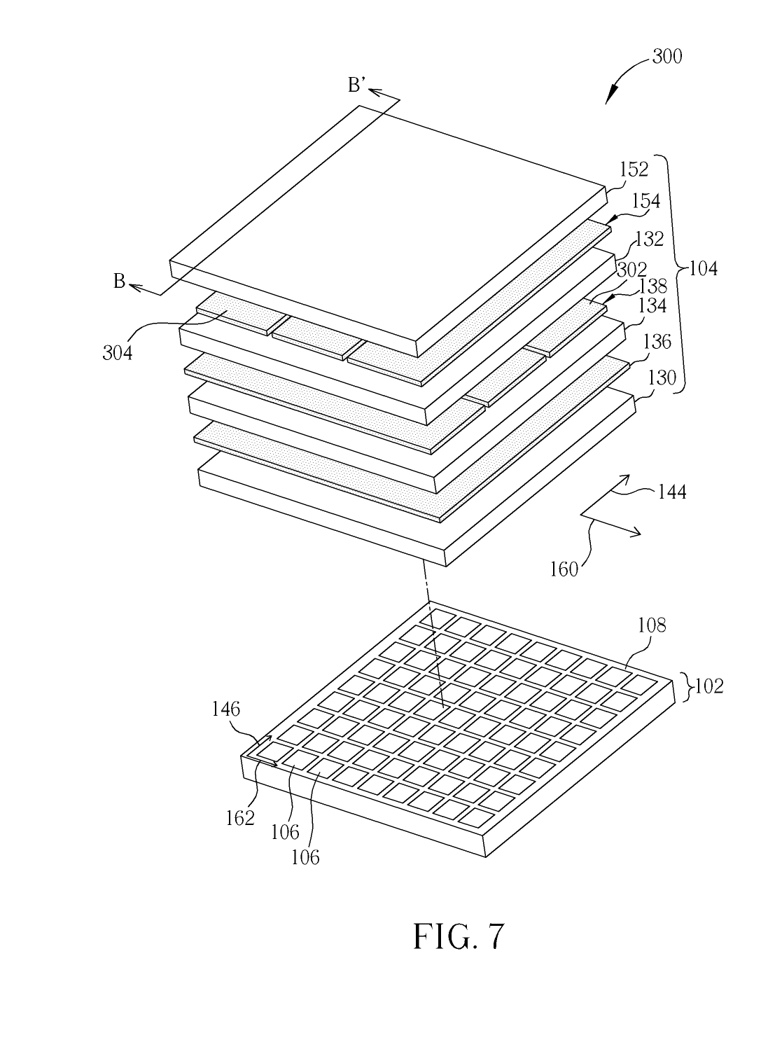

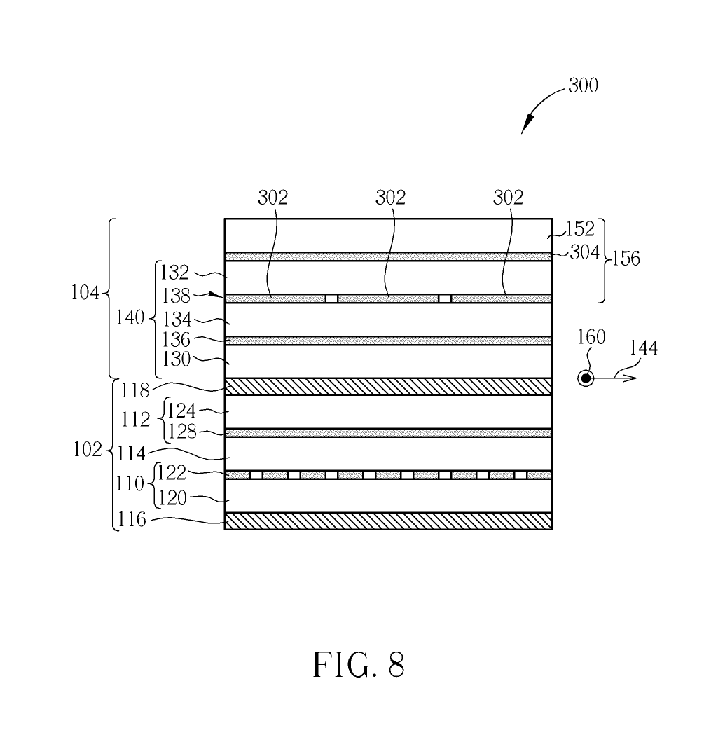

In addition, the number of the first sensing electrodes is not restricted to be equal to the number of the pixels in the same column. Please refer to FIG. 7 and FIG. 8. FIG. 7 is a three-dimensional schematic diagram showing a switchable stereoscopic display device according to the second embodiment of the invention. FIG. 8 is a schematic, cross-sectional diagram taken along a line BB′ in the FIG. 7. As shown in FIG. 7 and FIG. 8, the differences between the first embodiment and this embodiment are that the number of first sensing electrodes 302 is not equal to the number of the pixels 106 in the same column, and the number of second sensing electrodes 304 is not equal to the number of the pixels 106 in the same row. In this embodiment, the number of first sensing electrodes 302 is inferior to the number of the pixels 106 in the same column, and the number of second sensing electrodes 304 is inferior to the number of the pixels 106 in the same row. Each of the first sensing electrodes 302 approximately overlaps with the pixels 106 in at least two adjacent rows, and each of the second sensing electrodes 304 approximately overlaps with the pixels 106 in at least two adjacent columns. In other words, at least two adjacent first sensing electrodes 142, as described in the first embodiment, are combined to each first sensing electrode 302, as described in this embodiment. At least two adjacent second sensing electrodes 158, as described in the first embodiment, are combined to each second sensing electrode 304, as described in this embodiment. Furthermore, in order to let the first sensing electrodes 302 spot a touched position of a conductive object, the width of each first sensing electrodes 302 is preferably smaller than that of the object. It is worth noting that, as a switchable stereoscopic display panel 300 shows 3D images, the moving speed of liquid crystal molecules in the liquid crystal layer 134 is much slower than the speed of the signal transmitted to each first sensing electrodes 302. Therefore, the reduction of the number of the first sensing electrodes 302 would not change the polarization properties of the light of right eye images and the light of left eye images described in the above embodiment. According to this embodiment, the number of controlling ICs electrically connected to the first sensing electrodes 302 and the second sensing electrodes 304 may also be reduced to further lower manufacturing cost.

Besides, the number of the first sensing electrodes and the second sensing electrodes are not restricted to be inferior to the number of the pixels in the same column and in the same row, respectively. According to another embodiment, only the number of the first sensing electrodes is inferior to the number of the pixels in the same column or only the number of the second sensing electrodes is inferior to the number of the pixels in the same row. In addition, another quarter-wave retardation plate may be disposed between a display panel and an integrated panel, so that each first sensing electrodes overlaps with the pixels in at least two adjacent rows, but is not limited thereto.

In summary, the integrated panel which integrates a touch panel and a phase modulator in the same panel has a switchable stereoscopic display panel that still possesses touch function when displaying 2D images. Furthermore, the switchable stereoscopic display panel may be switched to display 3D images. In this way, the number of transparent substrates may be reduced and steps for fabricating additional transparent electrode layers located between a second transparent substrate and a third transparent substrate may be omitted. Therefore, the method for fabricating the integrated panel is cost-effective.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An integrated panel of a touch panel and a phase modulator, comprising:
a first transparent substrate;
a second transparent substrate disposed opposite to the first transparent substrate;
a liquid crystal layer disposed between the first transparent substrate and the second transparent substrate;
a first transparent electrode layer disposed between the first transparent substrate and the liquid crystal layer;
a second transparent electrode layer disposed between the second transparent substrate and the liquid crystal layer, wherein the first transparent substrate, the second transparent substrate, the liquid crystal layer, the first transparent electrode layer, and the second transparent electrode layer constitute the phase modulator;
a third transparent substrate disposed opposite to the second transparent substrate, wherein the second transparent substrate is disposed between the first transparent substrate and the third transparent substrate; and
a third transparent electrode layer disposed between the second transparent substrate and the third transparent substrate, wherein the second transparent electrode layer, the second transparent substrate, the third transparent substrate, and the third transparent electrode layer constitute the touch panel.

2. The integrated panel of the touch panel and the phase modulator according to claim 1, wherein the second transparent electrode layer is in contact with the second transparent substrate, and the third transparent electrode layer is in contact with the second transparent substrate.

3. The integrated panel of the touch panel and the phase modulator according to claim 1, wherein the second transparent electrode layer comprises a plurality of first sensing electrodes arranged along a first direction and the third transparent electrode layer comprises a plurality of second sensing electrodes arranged along a second direction perpendicular to the first direction.

4. A switchable stereoscopic display device, comprising:
a display panel comprising a plurality of pixels arranged in an array; and
an integrated panel disposed opposite to the display panel, the integrated panel comprising:
a first transparent substrate;
a second transparent substrate disposed opposite to the first transparent substrate, wherein the first transparent substrate is disposed between the display panel and the second transparent substrate;
a liquid crystal layer disposed between the first transparent substrate and the second transparent substrate;
a first transparent electrode layer disposed between the first transparent substrate and the liquid crystal layer;
a second transparent electrode layer disposed between the second transparent substrate and the liquid crystal layer, wherein the first transparent substrate, the second transparent substrate, the liquid crystal layer, the first transparent electrode layer, and the second transparent electrode layer constitute a phase modulator;
a third transparent substrate disposed opposite to the second transparent substrate, wherein the second transparent substrate is disposed between the first transparent substrate and the third transparent substrate; and
a third transparent electrode layer disposed between the second transparent substrate and the third transparent substrate, wherein the second transparent electrode layer, the second transparent substrate, the third transparent substrate, and the third transparent electrode layer constitute a touch panel.

5. The switchable stereoscopic display device according to claim 4, wherein the second transparent electrode layer is in contact with the second transparent substrate, and the third transparent electrode layer is in contact with the second transparent substrate.

6. The switchable stereoscopic display device according to claim 4, wherein the second transparent electrode layer comprises a plurality of first sensing electrodes arranged along a first direction, and the third transparent electrode layer comprises a plurality of second sensing electrodes arranged along a second direction perpendicular to the first direction.

7. The switchable stereoscopic display device according to claim 6, wherein the first direction is the same as a column direction of the array.

8. The switchable stereoscopic display device according to claim 6, wherein a number of the first sensing electrodes is inferior to or equal to a number of the pixels in a same column.

9. The switchable stereoscopic display device according to claim 6, wherein each of the first sensing electrodes respectively overlaps with the pixels of each row.

10. The switchable stereoscopic display device according to claim 6, wherein each of the first sensing electrodes overlaps with the pixels of at least two adjacent rows.

11. The switchable stereoscopic display device according to claim 6, wherein each of the second sensing electrodes overlaps with the pixels of at least two adjacent columns.

12. The switchable stereoscopic display device according to claim 4, wherein the display panel is a liquid crystal display panel, an organic light emitting diode panel, or a plasma display panel.

13. The switchable stereoscopic display device according to claim 4, further comprising a quarter-wave phase retardation plate disposed between the display panel and the integrated panel.
